(19) United States
(12) Patent Application Publication
(10) Pub. No.: US 2011/0226527 A1
(43) Pub. Date: Sep. 22, 2011

(54) PROTECTOIN ASSEMBLY FOR ELONGATE FLEXIBLE MEMBER AND METHOD OF INSTALLATION OF SUCH MEMBER

(76) Inventor: Gary Ritchie-Bland, Durham (GB)

(21) Appl. No.: 13/122,051

(22) PCT Filed: Sep. 25, 2009
(86) PCT No.: PCT/GB09/51261

§ 371 Date: Jun. 7, 2011

(30) Foreign Application Priority Data
Oct. 3, 2008 (GB) 0818118.2

(51) Int. Cl. H02G 3/18; B23P 19/00

(52) U.S. Cl. 174/669; 29/428

(57) ABSTRACT

A mechanical latch (14) for preventing damage to a cable passing through an aperture is disclosed. The mechanical latch comprises a housing (42) adapted to be inserted into an aperture in a first direction and having an internal bore (43) for allowing movement of a cable therethrough. Latch fingers (46) protrude from the housing for engaging an edge of the aperture to prevent removal of the housing from the aperture in a second direction, opposite to the first direction, after insertion of the housing into the aperture in said the direction, to prevent the cable from engaging the edge of the aperture.

The present invention relates to an assembly for protecting an elongate flexible member, and relates particularly, but not exclusively, to an assembly for protecting a cable passing through an aperture in a support pillar of an offshore turbine generator. The invention also relates to a method of installing an elongate flexible member into an aperture.

Power is collected from offshore wind driven turbine generators by connecting one or more generators together by means of electrical cables, and connecting at least one cable to a collection station from which power can be taken ashore by means of a further cable. The cables are connected at one end to a support pillar of the generator, which is generally embedded in the sea bed, and pass through an aperture in a wall of the support pillar from a connection point inside the support pillar, and rest on the sea bed outside of the support pillar. Because the cable outside of the support pillar is subjected to movement as a result if tides and weather, the cable is vulnerable to damage as a result of movement of that part of the cable which comes into contact with the edge of the aperture. In particular, contact with the edge of the aperture can cause the cable to be bent around a sufficiently small bend radius to cause damage. It is therefore necessary to protect cables such cables against damage.

One known arrangement for protecting cables from damage at the location at which they pass through the aperture in the support pillar of a turbine generator consists of attaching a cable protector (known as a J-tube) to the support. The J-tube has a straight part and a curved part and is mounted to the aperture such that the curved portion passes through the aperture. The J-tube then acts as a cable guide and prevents the bending radius about which the cable is bent at the edge of the aperture from becoming less than a specified minimum value which could cause damage to the cable.

The J-tube is mounted to the support pillar of the turbine either before or after installation of the support pillar into the seabed. However, this arrangement suffers from the drawback that because the supports are generally installed by driving them into the sea bed, which subjects the supports to significant mechanical stresses, J-tubes mounted to the support before installation of the support in the sea bed can become damaged or dislodged during subsequent installation of the support or must be made sufficiently robust that the cost becomes prohibitive. On the other hand, if the J-tube is mounted to the support pillar after installation of the support, the cost of installation becomes extremely high, as a result of the need for specialist equipment and personnel to carry out such offshore installation.

Another arrangement is known in which a support (known as an I-tube) is mounted to the external surface of the support for preventing the bending radius of the cable from becoming less than a specified minimum value. Although I-tubes are easier (and therefore less expensive) to install than J-tubes, installation is nonetheless expensive, and it is difficult to provide an I-tube having performance as satisfactory as that provided by a J-tube.

Preferred embodiments of the present invention seek to overcome one or more of the above disadvantages of the prior art.

According to an aspect of the present invention, there is provided a protection device for preventing damage to an elongate flexible member passing through an aperture, the device comprising:-

a body adapted to be inserted into an aperture in a first direction and having an internal passageway for allowing movement of an elongate flexible member therethrough; and

latching means on said body for engaging an edge of the aperture to prevent removal of the body from the aperture in a second direction, opposite to said first direction, after insertion of said body into said aperture in said first direction, to prevent the elongate flexible member from engaging the edge of the aperture.

By providing a protection device having latching means for engaging an edge of the aperture to prevent removal of the body from the aperture and prevent the elongate flexible member from engaging the edge of the aperture, this provides the advantage of providing easier installation of a device for preventing the bend radius of an elongate flexible member such as a cable or conduit from becoming less than a predetermined minimum value at the edge of the aperture. This therefore reduces the cost of installation of the elongate flexible member.

The latching means may comprise at least one latching member movable relative to said body between a first position enabling insertion of said body into said aperture in said first direction and a second position preventing removal of said body from said aperture in said second direction, and biasing means for biasing at least one said latching member towards the second position thereof.

At least one said latching member may have a respective inclined portion for engaging the edge of the aperture when the body is inserted into the aperture in said first direction.

This provides the advantage of making installation of the device easier.

The latching means may comprise a plurality of said latching members, wherein at least two said latching members are spaced apart in a direction along a longitudinal axis of said body.

This provides the advantage of improving the reliability of engagement between the device and the edge of the aperture.

At least one said latching member may be biased towards the second position thereof by means of at least one torsion spring arranged in the body.

This provides the advantage of enabling the device to be constructed more compactly and less expensively.

The device may further comprise at least one abutment portion arranged on said body for abutting the edge of the aperture to limit movement of the device through the aperture in said first direction.

The body may be adapted to be mounted to a flexible bend limiting device at a first and/or second end of said body.

This provides the advantage of minimising the risk of damage to a flexible elongate member such as a cable at end portions of the protection device.

According to another aspect of the present invention, there is provided a bend limiting device for resisting bending of an elongate flexible member passing through an aperture, the device comprising:-

an elongate flexible body adapted to pass through an aperture and having an internal passageway for allowing movement of an elongate flexible member therethrough; and

attachment means adjacent a first end of said body for enabling attachment of a pulling member thereto to enable pulling of the device through an aperture.

By suitable choice of the material and/or properties of the elongate flexible body, this provides the advantage of enabling bending of an elongate flexible member such as a cable passing through the bend limiting device to be resisted. This in turn provides the advantage of minimising the risk of damage to the elongate flexible member as a result of it being bent around too small a bend radius.

The attachment means may comprise at least one tensile member having an engagement portion adjacent a first end thereof.

At least one said tensile member may be at least partially embedded in said body.

This provides the advantage of minimising the risk of the tensile member becoming detached from the body.

The device may further comprise mounting means adjacent a second end of said body for mounting the device to a protection device as defined above.

At least one said tensile member may be attached to said mounting means adjacent a second end thereof.

This provides the advantage of minimising the risk of detachment of the tensile member from the body.

The attachment means may further comprise tension limiting means for limiting the tension applied to the device by means of a pulling member.

The tension limiting means may comprise at least one attachment device adapted to break when a tension applied thereto exceeds a predetermined level.

This provides the advantage of enabling a pulling member to be connected to the bend limiting device and to an elongate flexible member such as a cable passing through the bend limiting device, and to enable a protection device attached to the bend limiting device to be installed in an aperture, and the cable to be pulled through the protection device when installed in the aperture, in a single operation. This improves the ease of and reduces the cost of installation.

According to a further aspect of the present invention, there is provided a protection assembly for an elongate flexible member, the assembly comprising:-

a protection device as defined above; and

a first bend limiting device as defined above adapted to be mounted to a first end of the protection device.

The assembly may further comprise a second bend limiting device adapted to be mounted to a second end of said protection device, the second bend limiting device comprising an elongate flexible body having an internal passageway for passage of an elongate flexible member therethrough.

The second bend limiting device may be adapted to be attached to a third bend limiting device at a second end of said second bend limiting device.

The second bend limiting device may be adapted to be attached to a third bend limiting device by means of at least one groove in said body adjacent said second end.

The assembly may further comprise a third bend limiting device comprising a plurality of bend restriction members, wherein a plurality of said bend restriction members each have a respective passageway to enable passage of an elongate flexible member therethrough, and each said bend restriction member is adapted to be mounted to at least one further said bend restriction member to allow limited pivotal movement of said bend restriction members relative to each other.

According to a further aspect of the present invention, there is provided a method of inserting an elongate flexible member into an aperture, the method comprising:-

attaching a pulling member to attachment means of a bend limiting device of a protection assembly as defined above, wherein an elongate flexible member is mounted adjacent a first end of said bend limiting device such that said protection assembly is located adjacent a first end of said elongate flexible member and said pulling member extends through an aperture;

pulling, by means of said pulling member, the protection assembly in a first direction to cause the protection device of said protection assembly to engage an edge of the aperture; and

pulling the elongate flexible member through said protection assembly in said first direction.

By pulling the protection assembly in a first direction to cause the protection device to engage an edge of the aperture and pulling the elongate flexible member through the protection assembly in the first direction, this provides the advantage of simplifying and reducing the cost of the installation process.

The elongate flexible member may be pulled through the protection assembly by means of the pulling member.

This provides the advantage of simplifying installation.

The step of attaching the pulling member to said attachment means may comprise attaching the pulling member to said attachment means by means of tension limiting means adapted to limit the tension applied to the protection assembly by means of the pulling member.

By connecting the pulling member directly to the elongate flexible member and to the attachment means by means of the tension limiting means, this provides the advantage of enabling the protection assembly and elongate flexible member to both be installed in the aperture by means of the same pulling member in a single process.

The method may further comprise supporting the elongate flexible member at a location spaced from said aperture.

This provides the advantage of minimising the risk of damage to the elongate flexible member by controlling the bend radius to which the elongate flexible member is subjected.

The elongate flexible member may comprise a cable or conduit.

A preferred embodiment of the invention will now be described, by way of example only and not in any limitative sense, with reference to the accompanying drawings in which:-

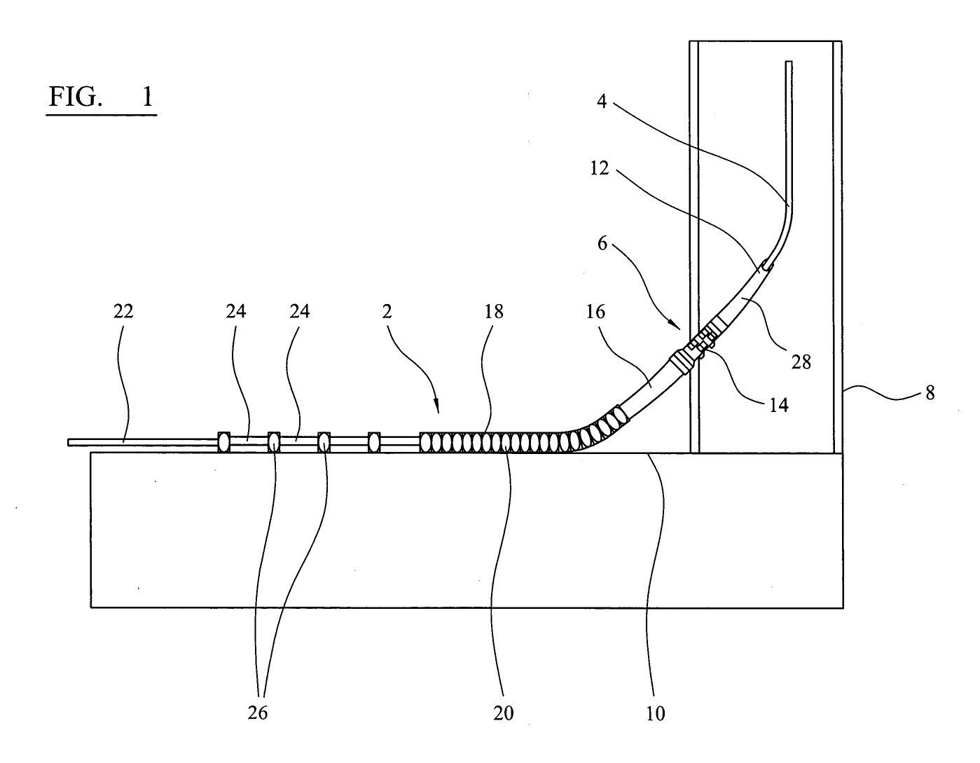

FIG. 1 is a schematic side view of a cable and cable protection assembly embodying the present invention installed in a support pillar of an offshore turbine generator;

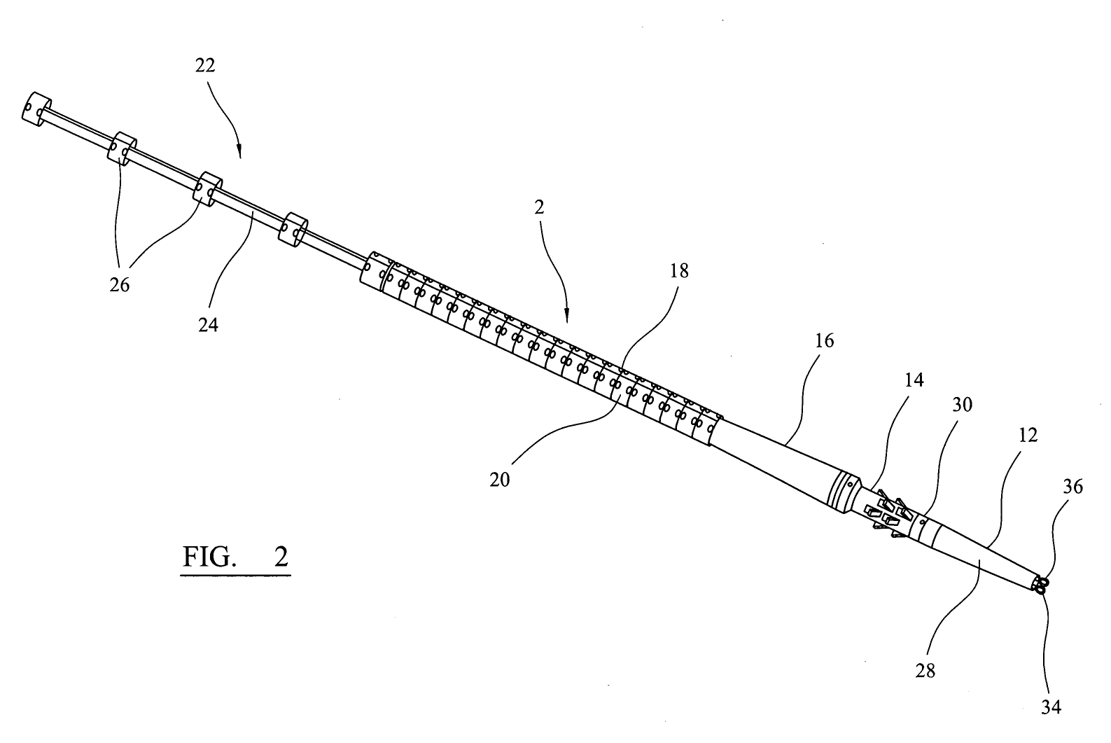

FIG. 2 is a perspective view of the cable protection assembly of FIG. 1;

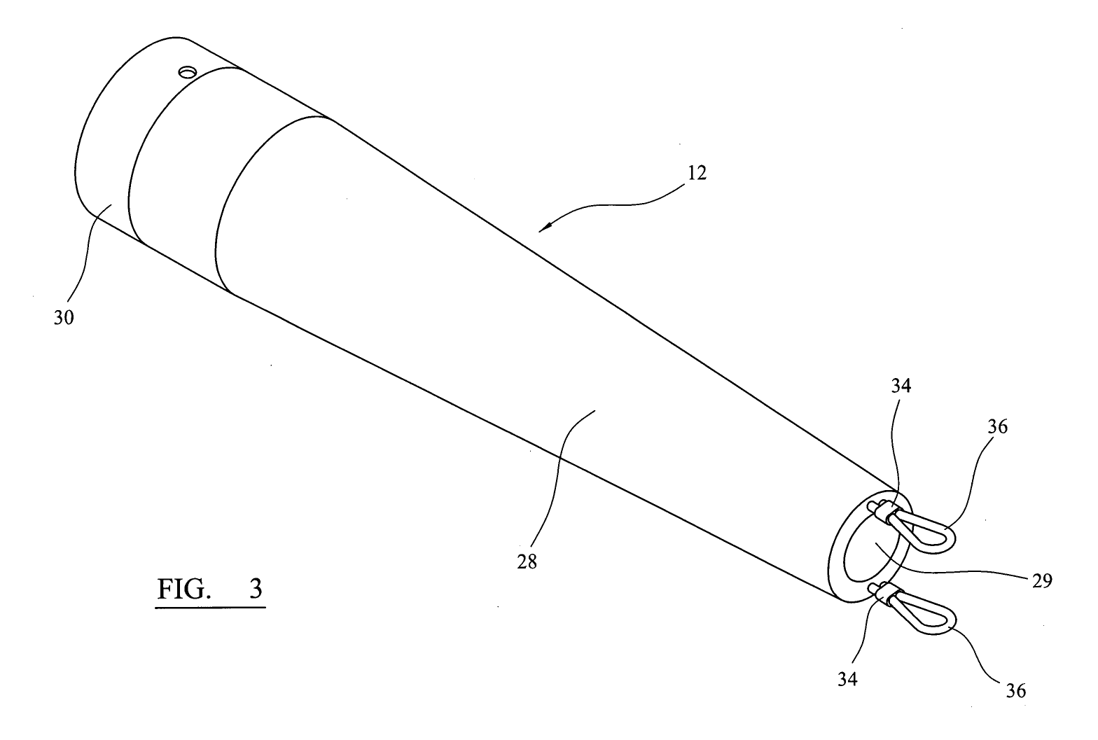

FIG. 3 is a perspective view of a first bend stiffener of the cable protection assembly of FIGS. 1 and 2;

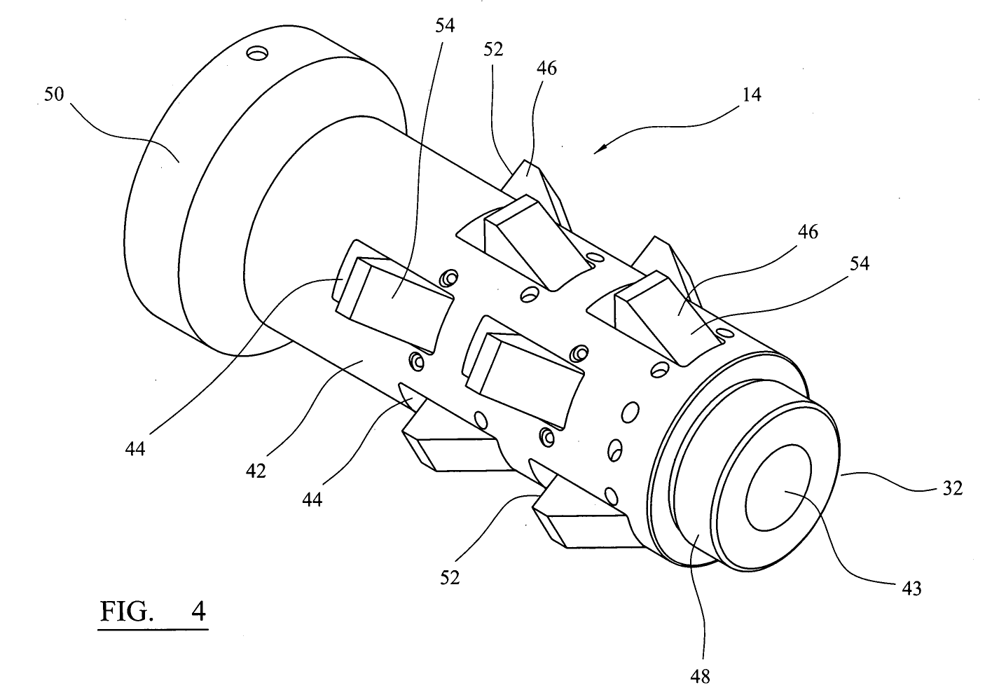

FIG. 4 is a perspective view of a latching device of the cable protection assembly of FIGS. 1 and 2;

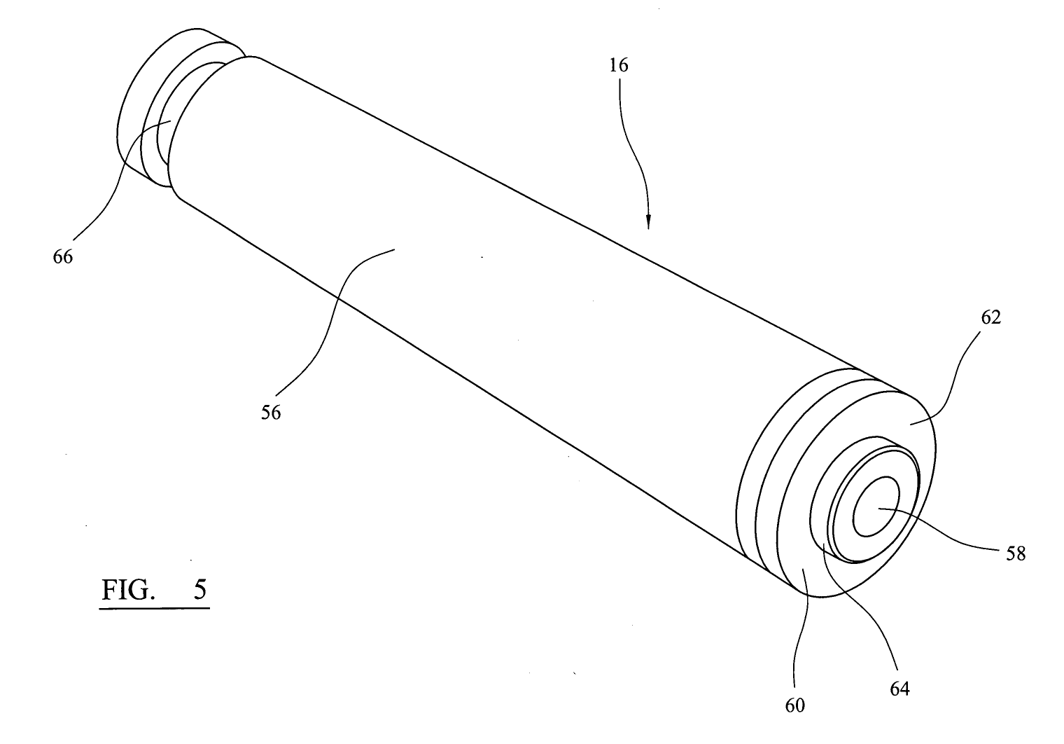

FIG. 5 is a perspective view of a second bend stiffener of the cable protection assembly of FIGS. 1 and 2;

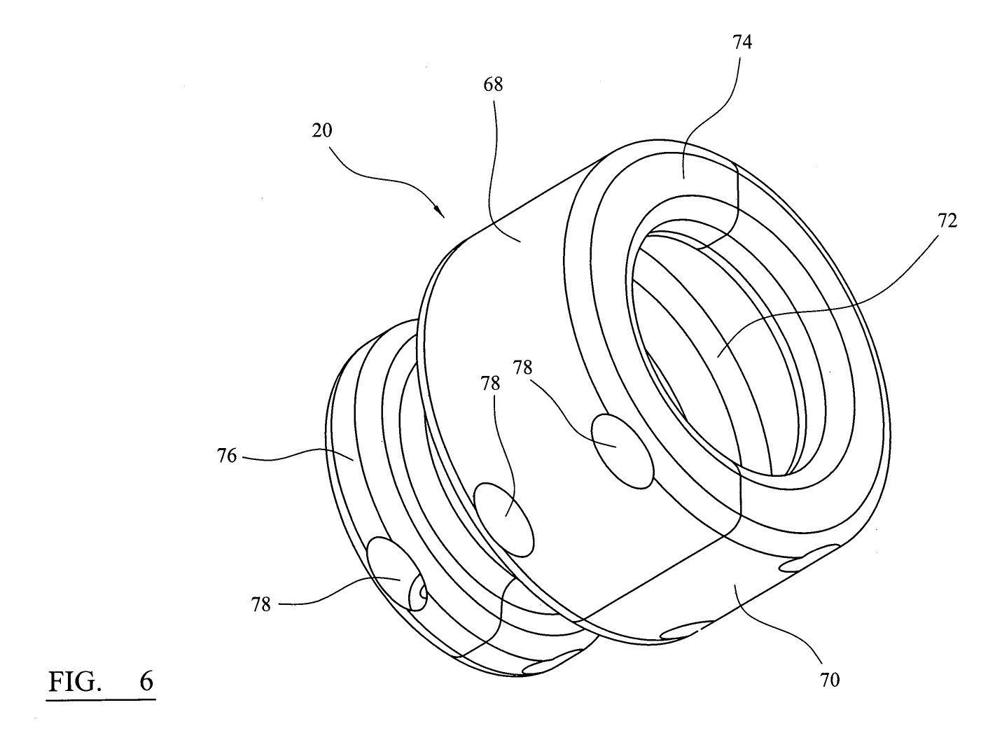

FIG. 6 is a perspective view of a bend restrictor element of the cable protection assembly of FIGS. 1 and 2; and

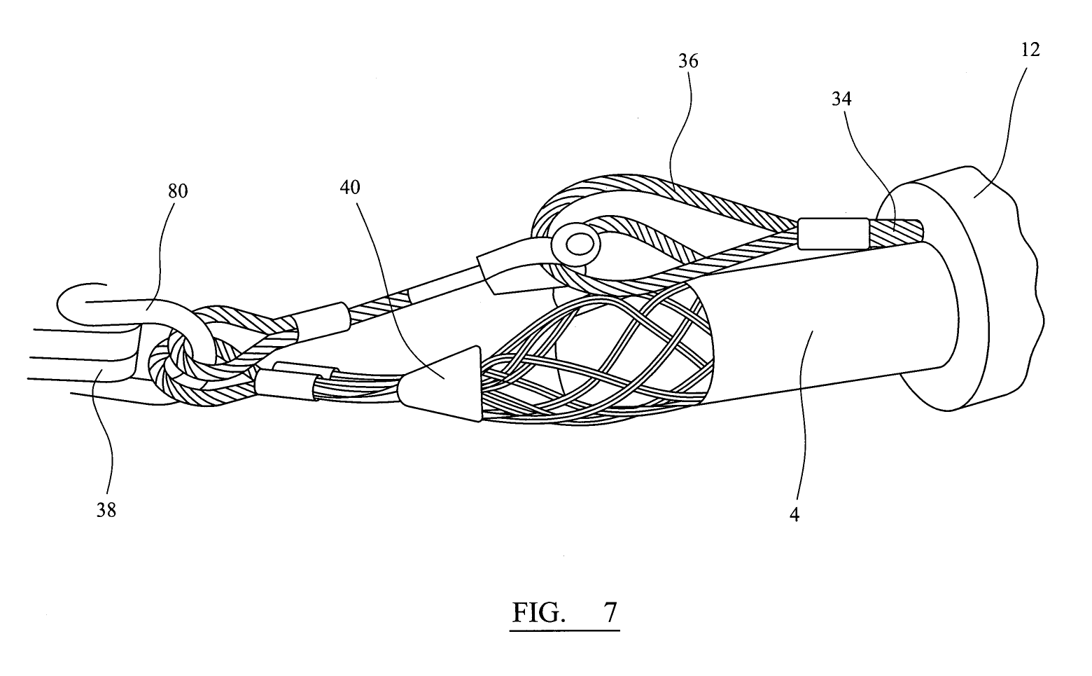

FIG. 7 is a perspective view of attachment devices for attaching a pulling line to the cable and cable protection assembly of FIG. 1.

FIG. 1 shows a schematic representation of a cable protection assembly 2 for enabling a flexible electrical cable 4 to be installed through an aperture 6 of a support pillar 8 of an offshore turbine generator (not shown) to enable the cable 4 to be connected to the generator and lie on the sea bed 10. The cable protection assembly 2 is designed to prevent the cable 4 from being bent around a bending radius sufficiently small to cause damage to the cable 4 at an edge of the aperture 6.

The cable protection assembly 2 comprises a first bend limiter 12 at a leading edge of the assembly 2, a mechanical latch 14 mounted to the first bend limiter 12 by means of co-operating threaded parts, a second bend limiter 16, mounted to the latch 14 by means of co-operating threaded parts, a third bend limiter 18 formed from a series of interconnected bend restrictor elements 20, and a fourth bend limiter 22 formed from a series of rigid tubes 24 connected end to end by means of polyurethane adaptors 26. A bell mouth bracket (not shown) may be included at the trailing end of the assembly 2 to enable a retrofit cable to be pulled through the assembly 2 while located subsea.

Referring to FIG. 3, the first bend limiter 12 has an elongate tapered body 28 formed from high grade polyurethane elastomer and having an internal bore 29 for passage of the cable 4. The body 28 has a threaded steel insert 30 to enable the first bend limiter 12 to be mounted to a leading end 32 of the mechanical latch 14 (FIG. 4). A pair of load bearing wire ropes 34 are attached to the insert 30 and are embedded in the elastomer body 28 to prevent removal of the ropes 34 from the body 28. The ropes 34 are provided with loops 36 for connection to a pulling line 38 (FIG. 7), which is pre-installed in the support pillar 8 and an end of which protrudes from the aperture 6, by means of one or more break-off wires 40 which are designed to break when a predetermined tension applied to the wire 40 is exceeded. By connecting the pulling line 38 to the first bend limiter 12 by means of one or more break-off wires 40 and connecting it directly to the leading end of the cable 4, when the break of wires 40 have been broken, the pulling line 38 is then only connected to the leading end of the cable 4, so that the cable 4 is then pulled through the cable protection assembly 2 by means of the pulling line 38.

Referring to FIG. 4, the mechanical latch 14 has a housing 42 formed from durable nylon and having an internal bore 43 for passage of the cable 4. The housing 42 has apertures 44 through which galvanised steel latch fingers 46 project. The leading end 32 of the housing 42 is provided with a screw thread 48 designed to co-operate with a corresponding screw thread on the insert 30 at the trailing end of the first bend limiter 12 (FIG. 3). The trailing end of the housing is provided with a steel flange 50 for abutting the edge of the aperture 6 in the support pillar 8 to prevent the flange 50 from being pulled into the aperture 6 when the cable protection assembly 2 is pulled into the aperture 6.

The latch fingers 46 are hinged to the housing 42 and are biased, by means of a heavy duty torsion spring (not shown), axially outwards of the housing 42 to a position in which trailing edges 52 of the latch fingers 46 prevent removal of the latch 14 from the aperture 6 in the support pillar 8. Leading faces 54 of the latch fingers 46 are inclined relative to the housing 42 to facilitate insertion of the latch 14 into the aperture 6 in the support pillar 8. The latch fingers 46 are arranged in rows such that latch fingers are arranged at more than one axial location on the external surface of the housing 42, to facilitate engagement of the latch fingers 46 with the edge of the aperture 6 in the support pillar 8.

FIG. 5 shows in more detail the second bend limiter 16. The bend limiter 16 has an elongate body 56 of high grade polyurethane elastomer having a central passageway 58 for passage of the cable 4. A leading end 60 of the bend limiter 16 is provided with a steel insert 62 having a screw thread 64 to enable mounting of the bend limiter 16 to the trailing end of the mechanical latch 14. An external groove 66 is provided near the trailing end of the bend limiter 16, in order to enable a bend restrictor element 20 (FIG. 6) at a leading end of the third bend limiter 18 to be mounted to the second bend limiter 16. The first and second bend limiters 12, 16 each have a body having sufficient flexibility to allow bending of the cable 4 passing therethrough, but are sufficiently resilient to prevent bending of the cable 4 around a sufficiently small bend radius to cause damage at the leading and trailing ends of the mechanical latch 14 respectively.

FIG. 6 shows a bend restrictor element 20 of the third bend limiter 18 of FIGS. 1 and 2. The bend restrictor element 20 is formed from two clamshell halves 68, 70 of polyurethane. The clamshell halves 68, 70 form a body having in internal bore 72 to enable passage of the cable 4, and the body has a widened head 74, having an internal diameter slightly wider than the external diameter of a tail portion 76 of an adjacent bend restrictor element 20, such that when the two clamshells 68, 70 of a first element 20 are fastened together by means of bolts (not shown) in holes 78 such that the head 74 of the first element 20 encloses the tail portion 76 of the second element 20, limited pivoting of the first and second elements 20 relative each other about an axis perpendicular to the longitudinal axes of the elements 20 is permitted. This limits the extent to which a cable 4 passing through the longitudinal bores 72 of the elements 20 can bend, which prevents the cable 4 being bent around a sufficiently small bend radius to cause damage.

FIG. 7 shows an attachment part 80 for attaching the pulling line 38, which is preinstalled in the support pillar 8, to the leading end of the assembly first bend limiter 12 and the leading end of the cable 4 such that the leading end of the cable 4 is located adjacent the leading end of the first bend limiter 12.

The operation of the cable protection assembly 2 shown in the figures will now be described.

The cable 4 is inserted into the assembly 2 prior to installation such that the leading end of the cable 4 protrudes slightly from the leading end of the first bend limiter 12. In order to carry out the installation process, the attachment part 80 of the pulling line 38 is retrieved by a diver or ROV (remotely operated vehicle) and transferred to the end of the cable 4 located on a vessel (not shown) at the surface such that the end of the pulling line 38 is attached directly to the leading end of the cable 4, and attached to the loops 36 at the leading end of the first bend limiter 12 by means of the break-off wire 40 as shown in FIG. 7.

The cable 4 passing through the cable protection assembly 2 is then supported at a suitable location along its length by means of suitable apparatus such as a crane or A-frame on a ship (not shown) which will be familiar to persons skilled in the art, such that the cable 4 forms a catenary curve in the water under its own weight. The cable 4 is then fed forwards, while the pulling line 38 is pulled, as a result of which the cable 4 and cable protection assembly 2 are pulled into the aperture 6. As the mechanical latch 14 enters the aperture 6, one or more of the latch fingers 46 engage the edge of the aperture 6 and are pushed inwards against the force of the torsion spring, until the movement of the latch 14 into the aperture 6 is limited by abutment of the flange 50 against the edge of the aperture 6. As the latch fingers pass 46 through the aperture 6, they can move axially outwards under the force of the torsion spring to their full extent, so that their trailing edges 52 prevent removal of the latch 14 from the aperture 6 by engaging the internal edge of the aperture 6.

As a result of engagement of the flange 50 against the external edge of the aperture 6, the tension in the pull line increases, as a result of which the break-off wire 40 eventually breaks. The latch 14 is then left in position in the aperture 6, but because the pulling line 38 is still connected to the leading end of the cable 4, the cable 4 can then be pulled through the cable protection assembly 2 and subsequently connected to the turbine (not shown). When the cable 4 has been pulled through the cable protection assembly 2 to the desired extent, the third and fourth bend limiters 18, 22 are laid on the sea bed 10, and the second end of the cable 4 is connected to a further turbine and/or power collection station (not shown).

It will be appreciated by persons skilled in the art that the above embodiment has been described by way of example only, and not in any limitative sense, and that various alterations and modifications are possible without departure from the scope of the invention as defined by the appended claims.

1. A protection device for preventing damage to an elongate flexible member passing through an aperture, the device comprising:-
a body adapted to be inserted into an aperture in a first direction and having an internal passageway for allowing movement of an elongate flexible member therethrough; and
at least one latching device on said body for engaging an edge of the aperture to prevent removal of the body from the aperture in a second direction, opposite to said first direction, after insertion of said body into said aperture in said first direction, to prevent the elongate flexible member from engaging the edge of the aperture.

2. A protection device according to claim 1, wherein at least one said latching device comprises at least one respective latching member movable relative to said body between a first position enabling insertion of said body into said aperture in said first direction and a second position preventing removal of said body from said aperture in said second direction, and at least one biasing device for biasing at least one said latching member towards the second position thereof.

3. A protection device according to claim 2, wherein at least one said latching member has a respective inclined portion for engaging the edge of the aperture when the body is inserted into the aperture in said first direction.

4. A protection device according to claim 2, wherein at least one said latching device comprises a respective plurality of said latching members, wherein at least two said latching members are spaced apart in a direction along a longitudinal axis of said body.

5. A protection device according to claim 2, wherein at least one said latching member is biased towards the second position thereof by means of at least one torsion spring arranged in the body.

6. A protection device according to claim 1, further comprising at least one abutment portion arranged on said body for abutting the edge of the aperture to limit movement of the device through the aperture in said first direction.

7. A protection device according to claim 1, wherein the body is adapted to be mounted to a flexible bend limiting device at a first and/or second end of said body.

8. A bend limiting device for resisting bending of an elongate flexible member passing through an aperture, the device comprising:-
an elongate flexible body adapted to pass through an aperture and having an internal passageway for allowing movement of an elongate flexible member therethrough; and
at least one attachment device adjacent a first end of said body for enabling attachment of a pulling member thereto to enable pulling of the device through an aperture.

9. A bend limiting device according to claim 8, wherein at least one said attachment device comprises at least one respective tensile member having an engagement portion adjacent a first end thereof.

10. A bend limiting device according to claim 9, wherein at least one said tensile member is at least partially embedded in said body.

11. A bend limiting device according to claim 8, further comprising at least one mounting device adjacent a second end of said body for mounting the device to a protection device comprising a body adapted to be inserted into an aperture in a first direction and having an internal passageway for allowing movement of an elongate flexible member therethrough, and at least one latching device on said body for engaging an edge of the aperture to prevent removal of the body from the aperture in a second direction, opposite to said first direction, after insertion of said body into said aperture in said first direction, to prevent the elongate flexible member from engaging the edge of the aperture.

12. A bend limiting device according to claim 11, wherein at least one said tensile member is attached to said mounting means adjacent a second end thereof.

13. A bend limiting device according to claim 8, wherein at least one said attachment device further comprises at least one respective tension limiting device for limiting the tension applied to the device by means of a pulling member.

14. A bend limiting device according to claim 8, wherein at least one said the tension limiting means device comprises at least one respective attachment device adapted to break when a tension applied thereto exceeds a predetermined level.

15. A protection assembly for an elongate flexible member, the assembly comprising:-
protection device for preventing damage to an elongate flexible member passing through an aperture, the protection device comprising:-
a body adapted to be inserted into an aperture in a first direction and having an internal passageway for allowing movement of an elongate flexible member therethrough; and
at least one latching device on said body for engaging an edge of the aperture to prevent removal of the body from the aperture in a second direction, opposite to said first direction, after insertion of said body into said aperture in said first direction, to prevent the elongate flexible member from engaging the edge of the aperture
a first bend limiting device for resisting bending of an elongate flexible member passing through an aperture, the bend limiting device comprising:-
an elongate flexible body adapted to pass through an aperture and having an internal passageway for allowing movement of an elongate flexible member therethrough; and
at least one attachment device adjacent a first end of said body for enabling attachment of a pulling member thereto to enable pulling of the device through an aperture, and adapted to be mounted to a first end of the protection device.

16. A protection assembly according to claim 15, further comprising a second bend limiting device adapted to be mounted to a second end of said protection device, the second bend limiting device comprising an elongate flexible body having an internal passageway for passage of an elongate flexible member therethrough.

17. A protection assembly according to claim 16, wherein the second bend limiting device is adapted to be attached to a third bend limiting device at a second end of said second bend limiting device.

18. A protection assembly according to claim 17, wherein the second bend limiting device is adapted to be attached to a third bend limiting device by means of at least one groove in said body adjacent said second end.

19. A protection assembly according to claim 15, further comprising a third bend limiting device comprising a plurality of bend restriction members, wherein a plurality of said bend restriction members each have a respective passageway to enable passage of an elongate flexible member therethrough, and each said bend restriction member is adapted to be mounted to at least one further said bend restriction member to allow limited pivotal movement of said bend restriction members relative to each other.

20. A method of inserting an elongate flexible member into an aperture, the method comprising:- attaching a pulling member to to at least one attachment device of a bend limiting device for resisting bending of an elongate flexible member passing through an aperture, the device comprising:-
an elongate flexible body adapted to pass through an aperture and having an internal passageway for allowing movement of an elongate flexible member therethrough; and
at least one attachment device adjacent a first end of said body for enabling attachment of a pulling member thereto to enable pulling of the device through an aperture, wherein an elongate flexible member is mounted adjacent a first end of said bend limiting device such that said protection assembly is located adjacent a first end of said elongate flexible member and said pulling member extends through an aperture,
pulling, by means of said pulling member, the protection assembly in a first direction to cause the protection device of said protection assembly to engage an edge of the aperture; and
pulling the elongate flexible member through said protection assembly in said first direction.

21. A method according to claim 20, wherein the elongate flexible member is pulled through the protection assembly by means of the pulling member.

22. A method according to claim 20, wherein the step of attaching the pulling member to at least one said attachment device comprises attaching the pulling member to said attachment device by means of at least one tension limiting device adapted to limit the tension applied to the protection assembly by means of the pulling member.

23. A method according to claim 20, further comprising supporting the elongate flexible member at a location spaced from said aperture.

24. A method according to claim 20, wherein the elongate flexible member comprises a cable or conduit.
